(19) United States
(12) Patent Application Publication
(10) Pub. No.: US 2006/0097518 A1
(43) Pub. Date: May 11, 2006

(54) Coating for a press sleeve

(76) Inventors: Kilian Bott, Bischofsheim (DE); Thomas Skorka, Radolfzell (DE)

Correspondence Address: Diller Ramik & Wight, Suite 101, 7345 McWhorter Place, Annandale, VA, 22003, US

(21) Appl. No.: 10/521,792

(22) PCT Filed: Jun. 17, 2003
(86) PCT No.: PCT/EP03/06358

§ 371 Date: Oct. 5, 2005

(30) Foreign Application Priority Data
Jul. 25, 2002 (DE) 102 33 968.6

(51) Int. Cl. F16L 13/14; F16L 19/04

(52) U.S. Cl. 285/382

(57) ABSTRACT

The shell for a press fitting for a tube of plastic or a plastic/metal compound material comprises a shell body (16) of a soft metal, a soft metal alloy or a plastic. Further, the shell is provided with a wax layer (22) at least in partial regions of the outer side (20) of the shell body (16).

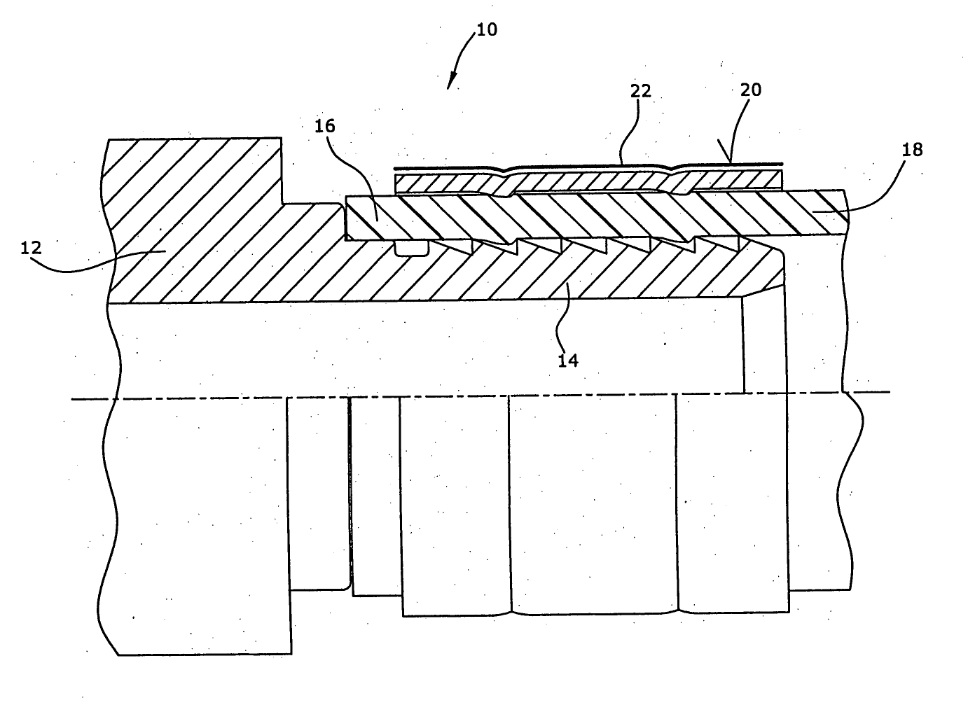

### BACKGROUND OF THE INVENTION

The invention relates to the coating of press shells in order to reduce the pressing forces as well as the cold welding of the press jaws and the press shell, and to increase the corrosion resistance and the lifespan of the press jaws and the pressing tools, and to establish a visual distinction between unpressed press shells and pressed press shells.

Tube connections established by means of press fittings are generally known (DE-C-196 37 608 and DE-C-197 49 748). Further, it is known that press shells of press fittings can also consist of soft materials; these will need considerably less pressing force than other press shells made of harder materials. One of the disadvantages of soft metal shells resides in the abrasive debris of shell material becoming attached to the press jaw surfaces during the press connecting process. This abrasive debris will considerably increase the pressing forces and can also lead to corrosion. A further consequence is the clogging of the press jaw with metallic shell material.

Further, it is known that tube connection systems can be covered by press shells comprising metals. Such a press shell is distributed e.g. by IPEX Inc., Canada and comprises copper with a tin coating. Also to these systems, the above statements apply in the same manner.

### SUMMARY OF THE INVENTION

It is an object of the invention to eliminate the negative effects of soft-material press shells and nonetheless maintain the good properties of a soft material shell.

The achieve the above object, there is proposed a shell for a press fitting provided for a tube of plastic or plastic/metal compound material, said shell comprising
a shell body comprising a non-iron metal and a non-iron metal alloy respectively, or plastic, and
a wax or solid lubricant layer at least in partial regions of the outer side of the shell body.

Further, according to the invention, there is proposed a method for pressing the press shell of a press fitting by means of a pressing tool comprising pressing jaws, according to which method a press shell comprising a non-iron metal and a non-iron metal alloy respectively, or plastic, is used and the outer side of the press shell and/or the press jaws of the pressing tool have been coated with a wax or a solid lubricant.

According to the invention, the press shell comprises a non-iron (NE) metal and an NE metal alloy, respectively, particularly an NE light metal and an NE light metal alloy, respectively (as particularly defined in DIN 17007). These will be aluminum or titanium as well as alloys thereof. Alternatively, the press shell can also comprise copper, magnesium or metals which are also used in the minting of coins. Further, it can be provided that the press shell comprises alloys of these metallic materials.

According to the invention, the coating can be a wax or a solid lubricant.

This coating of the press shell and the press jaws, respectively serves for reducing the friction between the press shell and the press jaws and will prevent cold welding. Further, the coating will avoid or reduce a mechanical jamming of the press shell and the press jaws/the jointing clamp.

The occurring adhesion forces are reduced. Thus, the coating comprises sliding materials. During the pressing process, these materials must not increase the pressing forces. The materials can be applied as a thin layer and will nonetheless adhere reliably. Adhesion of the coating in the press jaw surfaces is desired. The shells should not react corrosively with the coating material.

The following materials are suited for the coatings:
solid lubricants
   MOS₂,
   graphite and PTFE,
   the group of amorphous carbon compounds (a-C:H),
plastics,
paints,
stove lacquer (system Qualicoat),
oils,
paste,
   solid lubricant powders,
   solid lubricant pastes,
   solid lubricant dispersions and non-stick lacquers.

Waxes are been found to be most useful; these can be divided into herbal, hard, animal and mineral waxes. Among these four types of waxes, the group of mineral waxes has proven to be best suited. These waxes mainly comprise straight-chained hydrocarbons. These, however, can also include branched or cycloaliphatic hydrocarbons, depending on their composition. By way of alternative, solid lubricants can be used for coating the press shell.

The features of a press shell coated according to the invention or a press tool coated according to the invention are as follows:
good tribologic properties (low friction values with respect to the press jaw),
constant quality,
uniformity of color,
good adherence,
lightfastness,
weatherproofness,
good elasticity,
stress resistance,
temperature resistance up to 110 C,
softening point of the coating >110 C,
durable surface effect,
resistance to condensation water,
boil proof,
layer thickness as thin as possible,
good optical effect.

The coating the press shell should be performed or arranged exclusively on the outer surface of the press shell, notably at least in partial regions of the outer surfaces and, within such partial regions, particularly in those regions which are subjected to the largest pressing forces. The coating can be colored so that the installer can verify at one glance whether a pressing has been performed. By the pressing, the surface coating is deliberately “damaged”. Further still, the option exists to mark the fittings depending on the respective field of use, e.g. yellow press shells for gas.

### BRIEF DESCRIPTION OF THE DRAWING

An embodiment of the invention is illustrated in the drawing.

### DETAILED DESCRIPTION OF THE PREFERRED EMBODIMENTS

The press fitting 10 comprises a fitting body 12 which includes a support shell 14 for a tube end 16 to be connected and which is provided with a press shell 18 of a soft material (non-ferrous metal), such as e.g. aluminum, an aluminum alloy, copper or a copper alloy. Arranged on the outer surface 20 of press shell 18 is a coating schematically illustrated at 22. This coating comprises a herbal wax, animal wax, hard wax or mineral wax.

What is claimed is:

1. A shell for a press fitting for a tube of plastic or a plastic/metal compound material, comprising
a shell body (16) comprising a non-iron metal and a non-iron metal alloy respectively, or plastic, and
a wax or solid lubricant layer (22) at least in partial regions of the outer side (20) of the shell body (16).

2. A method for pressing the press shell of a press fitting by means of a pressing tool comprising press jaws, wherein a press shell (16) comprising a non-iron metal and a non-iron metal alloy respectively, or plastic, is used, and the outer side (20) of the press shell (16) and/or the press jaws of the pressing tool have been coated with a wax (22) or a solid lubricant.
